(19) United States
(12) Patent Application Publication
(10) Pub. No.: US 2008/0203352 A1
(43) Pub. Date: Aug. 28, 2008

(54) FORMULATION OF GRINDING COOLANT

(75) Inventors: Patrick Mark Hamill, County Tyrone (IE); James Mark Mallon, County Derry (IE)

Correspondence Address: Seagate Technology;c/o DARBY & DARBY P.C., P.O. Box 770, Church Street Station, New York, NY, 10008-0770, US

(73) Assignee: Seagate Technology LLC, Scotts Valley, CA (US)

(21) Appl. No.: 12/115,362

(22) Filed: May 5, 2008

Related U.S. Application Data
(62) Division of application No. 10/851,250, filed on May 24, 2004, now abandoned.
(60) Provisional application No. 60/493,228, filed on Aug. 6, 2003.

(30) Foreign Application Priority Data
Jun. 16, 2003 (GB) 0313925

(51) Int. Cl. C09K 5/00

(52) U.S. Cl. 252/71

(57) ABSTRACT

A new coolant for grinding the surface of the substrate of a magnetic recording medium is disclosed. The new coolant maintains the removal rate at about 1 mil/min even after 58 runs after dress. On the other hand, the removal rate using a commercially available coolant drops to less than 0.3 mil/min after only about 35 runs after dress.

### CROSS REFERENCE TO RELATED APPLICATIONS

This application is a divisional of U.S. Ser. No. 10/851,250, filed May 24, 2004, which claims priority from U.S. Provisional Application Ser. No. 60/493,228, filed Aug. 6, 2003, and British Patent Application No. 0313925, filed Jun. 16, 2003, the entire disclosures of which are hereby incorporated herein by reference.

### FIELD OF INVENTION

The present invention relates to grinding coolant formulation having particular applicability in the surface treatment of a substrate of high density magnetic recording media, particularly disk media.

### BACKGROUND

Magnetic disks and disk drives are conventionally employed for storing data in magnetizable form. Typically, one or more disks are rotated on a central axis in combination with data transducing heads positioned in close proximity to the recording surfaces of the disks and moved generally radially with respect thereto. Magnetic disks are usually housed in a magnetic disk unit in a stationary state with a magnetic head having a specific load elastically in contact with and pressed against the surface of the disk.

The increasing demands for higher areal recording density impose increasingly greater demands on flying the head lower because the output voltage of a disk drive (or the readback signal of a reader head in disk drive) is proportional to 1/exp(HMS), where HMS is the space between the head and the media. Therefore, a smooth recording surface is preferred, as well as a smooth opposing surface of the associated transducer head, thereby permitting the head and the disk to be positioned in closer proximity with an attendant increase in predictability and consistent behavior of the air bearing supporting the head.

Conventional techniques for producing a smooth surface on the disk include polishing and tape burnishing (buffing). Typically, the polishing is done using a coolant and buffing is done after sputtering. However, these conventional techniques are attendant with numerous disadvantages. For example, the problems that the inventors were experiencing with current coolants was that the removal rate capability of the grinding stone dropped off very quickly as a function of the run number after dressing the grinding stone with a diamond pellet dresser. The performance data of one current coolant is shown in the Comparative Example below. Thus with the prior art coolants, the condition of the grinding stone or cutting surface deteriorated rapidly resulting in an inconsistency in the grinding conditions and a loss in throughput due to increased grinding cycle times as the removal rate deteriorated. This problem of the current coolant caused a drop in the production throughput capability for producing a smooth surface on the disk substrate as the throughput per hour deteriorated rapidly with time.

The problem with the increased dress frequency of the grinding stones could be huge in terms of higher cost (grinding stone erosion and longevity of use, pellet dresser wear and longevity of use), lower throughput due to downtime (there could be approximately 30 minutes downtime to dress a grinding stone during which no production runs are processed) and poor quality.

Over the course of several years, the inventors evaluated a list of alternative coolants from various coolant vendors within the industry, but all of the commercially available coolants had a number of performance related issues such as foaming, issues with coolant waste flocculating/separating and issues with poor performance in the grinding process.

### SUMMARY OF THE INVENTION

An object of the present invention is to improve throughput and prolong stone dressing interval, which will both give us, cost benefits. One embodiment of this invention is a coolant for treating a non-magnetic substrate of a magnetic recording medium, comprising polyphosphoric acid and butoxyethanol or glycol ether. The coolant could further comprise an additive to neutralize pH of the coolant. The coolant could further comprise triethanolamine and potassium hydroxide. Preferably, 5 liters of the coolant contains about 50 g to about 1,000 g of the polyphosphoric acid, about 25 g to about 500 g of KOH, about 200 g to 2,000 g of 2-butoxy ethanol, about 100 g to about 1,200 g of triethanolamine and the balance of water. Preferably, the non-magnetic substrate is aluminum or an aluminum-containing substrate. Preferably, the coolant is an oxide scavenger. Preferably, the polyphosphoric acid has a pH in the range of about 1.0 to 7.0. Preferably, the coolant has a pH in the range of 2.0 to 7.0. Preferably, the coolant is substantially non-foaming. Preferably, the coolant produces a removal rate for the aluminum substrate of greater than 0.3 mil/min for at least 50 runs after dress of a grinding medium. Preferably, the removal rate is greater than 0.8 mil/min.

Another embodiment is a method for treating a non-magnetic substrate of a magnetic recording medium, comprising providing the non-magnetic substrate to a holding fixture and treating a surface of the non-magnetic substrate in the presence of a claimed coolant. The method could further comprise texturing the non-magnetic substrate and exposing the non-magnetic substrate to an acidic solution or acidic cleaner, spaying de-ionized water on the non-magnetic substrate, soaking the non-magnetic substrate in an alkaline soap solution, soaking the non-magnetic substrate in an alkaline soap solution with ultrasonic agitation, soaking the non-magnetic substrate in a de-ionized water bath with ultrasonic agitation, scrubbing the non-magnetic substrate, and drying the non-magnetic substrate.

Another embodiment is a method for treating a non-magnetic substrate of a magnetic recording medium, comprising providing the non-magnetic substrate to a holding fixture and treating a surface of the non-magnetic substrate in the presence of a claimed coolant.

Additional advantages of this invention will become readily apparent to those skilled in this art from the following detailed description, wherein only the preferred embodiments of this invention is shown and described, simply by way of illustration of the best mode contemplated for carrying out this invention. As will be realized, this invention is capable of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

FIG. 1 schematically illustrates an exemplary process flow chart for the development of a grinding coolant formulation of this invention.

FIG. 2 shows results of foaming tests.

FIG. 3 shows the removal rate of an aluminum substrate as a function of run number after dress of a new coolant (top line) and a commercially available coolant (lower line).

### DETAILED DESCRIPTION

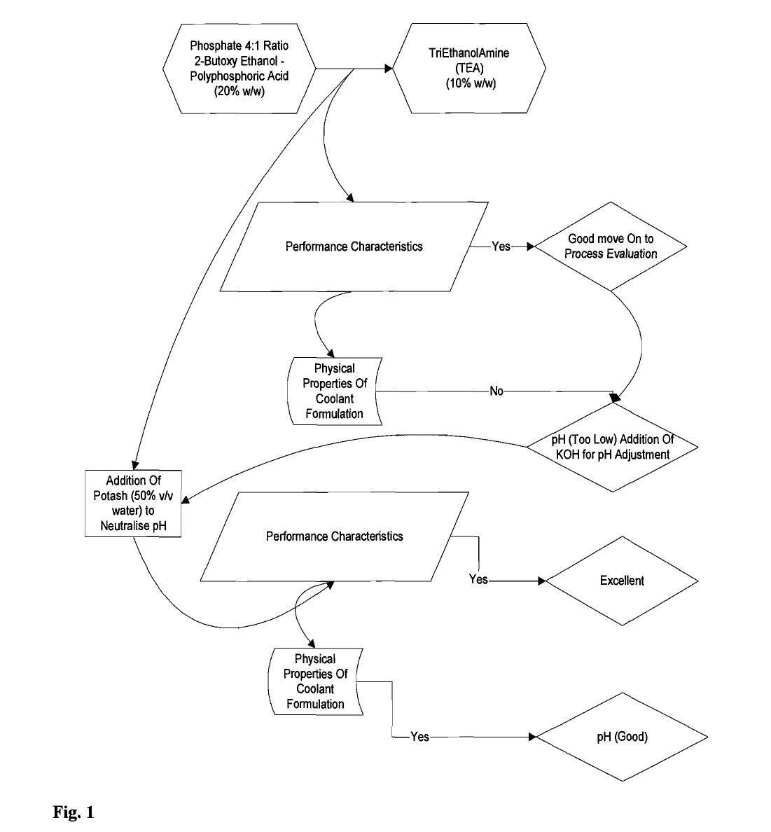

A flowchart of the development of the new grinding coolant formulation of one embodiment of this invention is schematically illustrated in FIG. 1. The initial process evaluations by the inventors showed that phosphate-ester was the main active component for a grinding coolant. Thus, the inventors formulated a phosphate-ester that could provide the desired benefits of throughput. Subsequently, the inventors investigated the safety aspects, particularly pH, as phosphate-esters have a very low pH. Hence, the inventors investigated the effect of the addition of triethyl alcohol (TEA) to help raise pH and also to react or neutralize any access polyphosphoric acid that may have been left over from the phosphate-ester reaction. This combination resulted in a coolant that worked well in terms of throughput and removal rate, but there could be issues with the cost and amount of TEA required to neutralize the pH and the presence of foaming. Therefore, the inventors then investigated the effect of adding potash as a cheaper alternative to TEA as a pH adjusting agent. The inventors then unexpectedly found that potash could change the phosphate-ester reaction equilibrium. Hence, the inventors arrived at a unique approach of carrying out a partial TEA neutralization followed by a final pH adjustment with potash. The addition of potash in the condition of KOH 50% by weight in water also resulted in a coolant with a very effective foam suppressant property.

A method of surface treating a non-magnetic substrate of a magnetic recording medium comprises providing the non-magnetic substrate, applying a grinding stone or moving tape and a coolant to a surface of the non-magnetic substrate to produce a surface, which could then be treated with an acid solution and washed with de-ionized (DI) water. In a further extension of the embodiment, the surface could be further washed in an alkaline solution in an ultrasonic bath, and further washed with DI water.

The surface of media after acid treatment is preferably hydrophilic and has a water contact angle value less than a value selected from group consisting of 60°, 55°, 50°, 45°, 40°, 35°, 30°, 25°, 20°, 15°, 10°, 5°, and 1°. In other embodiments, the surface has a maximum difference in height between the highest and lowest points on the smooth surface relative to a mean plane of less than 5 nm, preferably less than 4 nm, most preferably less than 3 nm.

The wash/polish process of this invention could be used before thin film sputter deposition on the surface of the non-magnetic substrate. The method of this invention can be used on a non-magnetic substrate comprising glass, NiP/aluminum, metal alloys, plastic/polymer material, ceramic, glass-ceramic, glass-polymer and other composite materials, but most preferably an aluminum-containing substrate.

The new coolant could be a coolant for diamond pellet dressers, polyvinyl alcohol stones, Aramid carriers, etc. as the grinding medium. The diamond pellet dressers are used to refresh the stone. One embodiment of the diamond pellet dresser has 2 rows of 40 pellets of a monocrystalline diamond in a bronze/sintered matrix mounted on a stainless steel base. The PVA stone formulation typically contains silicon carbide grit 65-69% by weight, polyvinyl alcohol 13-17% by weight and thermosetting resin 16-20% by weight. The Aramid carriers contain aluminum-containing substrates that are positioned inside the pockets of these carriers during the grinding process. The Aramid carriers are made of Aramid material based on a Kevlar Composite. In other embodiments, the new coolant and a moving tape could be applied to the surface with a roller forcing the tape to contact the surface being polished or there could be an additional wiping process.

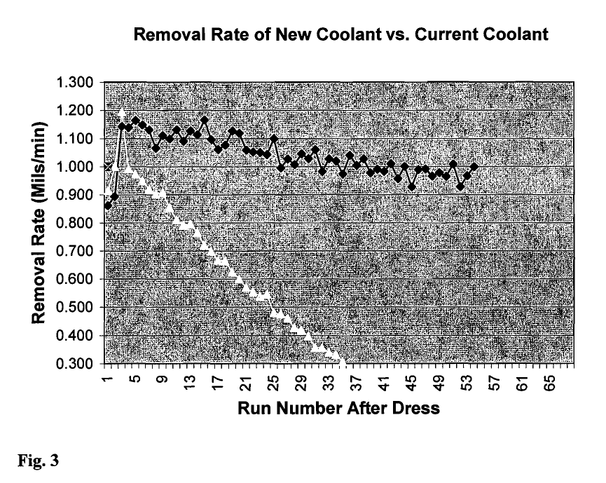

The new coolant acts as a very effective oxide scavenger on an aluminum substrate, and, thus prevents the build up of a surface layer of aluminum oxide on the surface of the grinding medium, e.g., the stone (cutting) surface. An oxide scavenger is a material that aids the coolant to substantially prevent the formation or accumulation of an oxide of aluminum (e.g., Al₂O₃) on the surface of the stone. The affects of an oxide scavenger can be observed and depicted by a graph such as that shown in FIG. 3 (which is discussed in the Example below), showing the resulting performance characteristics of different coolants. The resulting loss of removal on the stone could also be accompanied by blackening of the grinding stone. The amount of blackening could be monitored visually or can be characterized on a spent stone by scanning electron microscopy (SEM). This build up of an oxide of aluminum could deteriorate the stock removal (cutting rate) of an aluminum-containing substrate being polished.

In one embodiment of this invention, the inventors derived the formulation of the new coolant by evaluating a waste grinding coolant “ultra-filtration” process using about 0.1 micron pore size polyvinylidene fluoride (PVDF) membranes on a polyester support to ascertain which of the individual coolant components would be destroyed or broken down due to process degradation or would be stripped through the ultra-filtration process. In the waste grinding coolant “ultra-filtration” process, the inventors recycled all of the waste grinding coolant through an ultra-filtration process where the waste grinding coolant was filtered through the PVDF ultra-filtration membrane to remove the aluminum fines in suspension. The filtered coolant was reclaimed as a solvent and recycled to the grinding process.

In this set of evaluations, the inventors determined the coolant components before and after being used in a grinding operation and, thus, ascertained if the properties of a coolant were changing through continuous coolant recycling processes. The determination of the coolant components was done via GCMS and FTIR analysis. After identifying the coolant components, the inventors added the components to a solvent (e.g., water) one by one to obtain different coolant compositions. Then, the different coolant compositions were evaluated to derive the functionality of the coolant components in terms of the process performance rate of degradation through the grinding operation and the rate of strip out through the ultra-filtration process.

In one embodiment, one of the components of the coolants could be phosphate acid ester, which could be a combination of a polyphosphoric acid and butoxy ethanol or glycol ether groups to form a phosphate ester combination. A coolant with a phosphate ester combination as a component of the coolant performed much better than a commercial coolant because it is believed that the phosphate ester itself acts excellently as an effective coolant and oxide scavenger to keep the grinding stones surface oxide clean and maintain grinding performance for a long time. However, due to the low pH of a phosphate ester combination, secondary chemicals such as triethanolamine and potassium hydroxide could be added to the coolant to neutralize the pH, thereby brining the pH closer to 7.

The preferred coolant of this invention is substantially non-foaming without either a defoamer additive or secondary phosphonate salts. The other additional benefit of the new coolant is that the inventors know the exact formulation of the coolant in terms of the chemicals in the new coolant, thereby making is easy to fingerprint the individual components and determine how they could be changing through numerous process and recycling cycles.

The grinding process of the aluminum substrate for the purposes of evaluating different substrates or different coolants is as follows. First, one should keep all of the input variables constant. For example, one should test coolants from the same raw coolant lot that has been made up by the same method, to the same point of use concentration, which is measured to the same conductivity with the same measurement instrumentation. Second, the same process machine should be used to grind the parts with the grinding stone and with the coolant temperatures, flow rates controlled to the same target set points. Third, the blanks should be the same and the same target stock removal should be maintained for repetitive trials along with the same diamond dress process and the same diamond dresser set used. Thus, all these input variables should be maintained substantially the same from one test sample to another.

The primary performance characteristics of the coolant that the inventors investigated are the following.

Removal rate (mil/min): It is a stock removal rate of an aluminum substrate during a continuous grinding process and is defined by the ratio of a thickness of a stock removed to a grinding cycle time required for the removal of said thickness. The grinding cycle time is the time taken to remove a target stock thickness, e.g., 1.7 mils, from an incoming starting aluminum blank thickness to reach a set desired final thickness target on the finished ground substrate. For example, if an incoming blank thickness is 50.9 mils and the desired target stock removal is 1.7 mils, then the target thickness would be set at 49.2 mils and the required grinding cycle time would be the time taken to remove 1.7 mils, which is to reach the target thickness of 49.2 mils. The total stock removed is the difference between an original substrate stock thickness and a final substrate thickness after grinding the aluminum substrate for the required grinding cycle time. The original substrate thickness is the range of aluminum blank thickness as supplied for use. This normally is supplied for use in thickness ranges from 50.6 mils up to 51.2 mils in intervals of 0.1 mil distribution sizes. The removal rate is the total time taken to achieve the total target stock thickness removal as displayed in mils/minute. For example, if the target total stock removal is 1.5 mils and the total required process cycle time is 3 minutes, then the removal rate would have equal to 0.5 mils/min.

The run number after dress (“dress interval”): It is the number of runs after a standard stone dress for which the stone is capable of running before the stock removal rate drops off below a minimum set target of 0.3 mils/min. A “standard stone dress” is the number of runs which can be achieved after a stone dressing of 2 minutes cycle time with a set of 6 one-sided diamond pellet dressers which are loaded alternating into the grinding machine with the pellets alternating (pellets facing the upper stone and then the bottom stone) and placed equidistantly around the platen or stone circumference. The dressing interval is the number of runs that can be obtained after a stone dress before the removal rate drops below a lower limit threshold of 0.3 mils/min, which then triggers the action to redress or refresh the stone with a diamond pellet dresser. The diamond pellet dresser could be a monocrystalline diamond in a Bronze/sintered matrix at a concentration of diamond of 0.88 carats per cubic centimeter or 5% by volume of the total bond matrix. There could be 80 pellets in total constructed in 2 rows of 40 pellets mounted circumferentially onto a stainless steel wheel base whose teeth engage the grinding machine's outer rung gear and inner sun gear teeth during rotation. Preferably, one should dress/refresh the grinding stone every time the stone becomes loaded with a hard aluminum oxide layer, which is triggered when the removal rate drops below our lower limit threshold of 0.3 mils/min. At that point, one should complete the dress process with the diamond pellet dressers to dress the saturated stone sludge layer and expose a fresh & clean stone surface to regain an improved removal rate. When the removal rate drops below the minimum set target, the throughput efficiency could drop to a level such that the cycle times get longer and it could be more efficient to dress the stone than to run ever increasing cycle times as the stone surface has oxidized and loaded, and, therefore needs to be refreshed or re-dressed to regain an increased removal rate. The typical stone-dressing interval during disc manufacturing is generally about 20 minutes, which is lost production time.

Foaming: This is a semi-quantitative test. A 200 ml volume of the coolant or coolant solution was poured into a 500 ml container and vigorously shaken to see the extent of foam formation in terms of the height of the foam on the 500 ml vessel and also the time before the foam suppresses again naturally under gravity at room temperature and under atmospheric pressure. Test method and results for quantification of foaming are given below.

Equipment: 50 cm³ measuring cylinder with quick fit glass stopper, thermometer, 100 cm³ volumetric cylinder, auto-pipette and disposable tips, clock, coolant sample.

Method: Dilute neat coolant sample to 0.5% by volume with RODI water using an auto-pipette and volumetric flask. Invert flask gently several times to ensure complete mixing but to prevent foaming. Pipette 10 cm³ of the dilute solution into a clean dry 50 ml glass measuring cylinder with 1 cm³ gradations. Measure solution temperature this should be 20° C.±0.25. Measure solution volume note this as time=zero, volume=10. Start clock and shake the flask vigorously with up/down motion over a 30 cm range for 30 seconds. Allow solution to settle for 30 seconds and measure the combined volume of solution and foam at the uppermost level of foam observed. Continue measurements at 30 second intervals until time equals 180 seconds; then measure volume at 15 minutes and each subsequent 15 minutes until 1 hour has passed. Plot results of volume versus time. Optimum coolant is considered to be coolant with fastest foam collapse.

Results: Four coolants were tested under this methodology. Two were provided by Innovative Organics the others were standard BelDun1 coolant (denoted as 1a in the experiment) and BelDun1 with slight reformulation (denoted as 1b in the experiment). Table 1 shows the results of time (seconds) versus volume of coolant/foam.

TABLE 1

| Time | | | | |
|---|---|---|---|---|
| (sec) | IO 223 | IO 330A | BelDun1a | BelDun1b |
| 0 | 10 | 10 | 10 | 10 |
| 60 | 30 | 32 | 10 | 10 |
| 90 | 15 | 32 | 10 | 10 |
| 120 | 13 | 32 | 10 | 10 |
| 150 | 12 | 31.5 | 10 | 10 |
| 180 | 12 | 29 | 10 | 10 |
| 210 | 12 | 28 | 10 | 10 |
| 900 | 12 | 15 | 10 | 10 |
| 1800 | 12 | 11 | 10 | 10 |
| 2700 | 12 | 11 | 10 | 10 |
| 3600 | 12 | 11 | 10 | 10 |

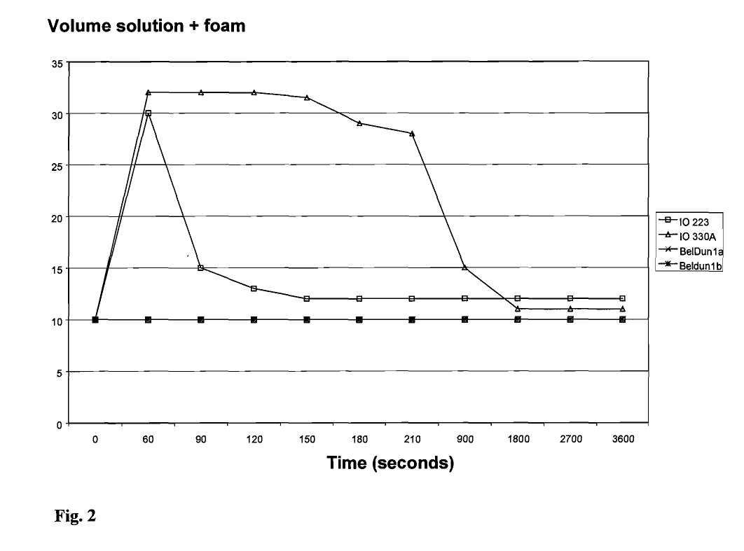

FIG. 2 is a plot charting time (seconds) versus volume of coolant/foam. The results indicate that the coolant with longest foam retention is Innovative Organics Ambercut 330A followed by Innovative Organics Ambercut 223. BelDun1a/b have exactly the same low foam abilities and have been deemed to display optimum requirements for a grind coolant. Note that the results of BelDun1a/b seem to overlap substantially.

A visual stone surface inspection during grinding: With normal coolants that are ineffective oxide scavengers, the stone visually oxidizes very quickly from a starting clean surface post dressing by blackening with increasing runs post dress cycle. On the other hand, with the new coolant this effect was minimized as the stone surface stayed clean for much longer, for at least 50 runs post dress and at a much higher average removal rate.

Throughput: This is measured as the number of process runs completed per hour. By the use of the new coolant, throughput increased as the cycle times remained shorter for many runs after dress

In the above process, the grinding treatment could be performed within or near the texture machine, just after mechanical texture without removal of the disk from the texture machine. Before or after grinding treatment, an acidic cleaner could be used to clean the rigid disk. The disk could be further cleaned with an alkaline soap or acidic cleaner solution with ultrasonic excitation. The disk could be further scrubbed and dried. The disk could typically be laser textured. After such laser texturing, the disk could be washed and dried.

In other embodiments of this invention the variations in polishing could be the following.

### Mechanical Polishing

Persons skilled in this art would recognize that the variables that control mechanical polishing are: substrate surface initial condition: roughness, waviness, substrate size, substrate shape and grain size; polishing slurry size (Al₂O₃, CeO₂, SiO₂, etc) and coolant (inorganic and organic solutions with lubricant); polishing time and surface finishing; and washing and cleaning substrate surface

### Chemical Polishing

Persons skilled in this art would recognize that the variables that control chemical polishing are: substrate surface initial condition: roughness, waviness, substrate size, substrate shape and grain size; polishing solutions compositions and their ability to dissolve the substrate materials; the composition consists of a combination of different acids (e.g. nitric, sulfuric, hydrochloric, phosphoric, chromic, acetic) or organic solutions (e.g. methanol, glycerin, ethyldiglycol), also containing some added electropositive ions. E.g., polishing of Al: small amounts of Cu will create additional local cathodes by deposition on Al, stimulating the polishing process. Adding some oxidants has a function as depolarization agents.

### Electrochemical Polishing

Persons skilled in this art would recognize that the variables that control electrochemical polishing are: The external source of electricity to produce the anodic current density and voltage; the electrolyte temperature; the time duration of electro-polishing; the cathodic materials; in general, the cathode surface should be many times larger than that of electro-polished substrate. Different materials are used as cathodes depending on the applied electrolyte; and agitation, which can eliminates the undesired concentration of the dissolved material at the substrate. Agitation can improve the supply of fresh electro-polishing electrolyte to substrate surface. Agitation can prevent local heating and release gas bubbles from the polished surface to avoid pitting on the substrate surface

CMP (Chemical Mechanical Polishing) used in semiconductor wafer polishing. Persons skilled in this art would recognize that the variables that control the CMP process.

### EXAMPLES AND COMPARATIVE EXAMPLES

In one embodiment, a new grinding coolant is a mixture in the following ratios:

By Volume Total volume of the new coolant=5 liters

```
  220 ml polyphosphoric acid
  424 ml of 50% v/v potash in water
  770 ml 2-butoxy ethanol
  500 ml triethanolamine
3086 ml of water
```

By Weight Total weight of the new coolant=5013 g

```
  462 g polyphosphoric acid
  693 g 2-butoxy ethanol
  212 g KOH pellet
  560 g triethanolamine
3086 g water
```

FIG. 3 shows the removal rate of an aluminum substrate as a function of run numbers after dress of the new coolant (top line) and of a commercially available coolant (lower line) called Innovative Organics Ambercut 223. The material safety data sheet of Ambercut 223 states that the coolant contains triethanolamine and the balance non-hazardous ingredients. FIG. 3 clearly shows that the new coolant of this invention maintains the removal rate at about 1 mil/min even after 58 runs after dress. On the other hand, the removal rate using the commercially available coolant drops to less than 0.3 mil/min after only about 35 runs after dress. The incoming thickness for the new coolant trial was 50.656 mils and the target thickness was set at 49.05 mils, hence a target removal of 1.606 mils. For the control current coolant, the incoming thickness was 50.552 mils and the target thickness was 48.953 mils hence a target stock removal of 1.599 mils.

The grinding cycle for the experiments whose data is shown in FIG. 3 was the following. The average removal grinding cycle for the new coolant was 99.41 seconds over an average of 54 runs whilst for the current coolant the average removal grinding cycle was 161.69 seconds over an average of 35 runs by which time the stone needed to be redressed. The grinding stone was NTK PVA Stone C#4000H313.

The grinding operation was carried out as follows. For each trial the same process machine was selected, the same coolant supply tanks were selected, the same coolant flow rates were used, the same ring pellet dresser set was used for each trial, the same dress process settings were used and the same stone flatness profile curvature was achieved for each trial before commencing. Furthermore, substantially identical blanks (Furukawa FP-3 Alloy) from the same blank vendors were used for each trial. The blanks were from the same blank chemical lot and the exact incoming thickness was measured so that the inventors could accurately adjust the target thickness to achieve as close as possible stock removal rate targets for each trial. The trials were then run on consecutive days on the same process machine under the supervision of the same set of process engineers, technicians and operators for consistency reasons. The resulting trial thickness control data was measured every run from an in-line federal air gauge on the machine which measured one part every run post the run completion and then sent the data to a data capture network where removal rates are calculated and collated by measuring the difference from the measured blank sample thickness—the resulting final thickness (+/− the set target) and divided by the total required removal cycle time to achieve the target thickness in seconds which then gave total stock removal achieved in mils per second. The inventors then multiplied this value by 60 to convert to mils/min, which is commonly used unit for reporting removal rate.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations. Persons skilled in the art would recognize that the numerical ranges disclosed inherently support any range within the disclosed numerical ranges even though a precise range limitation is not stated verbatim in the specification because this invention can be practiced throughout the disclosed numerical ranges. A holding to the contrary would “let form triumph over substance” and allow the written description requirement to eviscerate claims that might be narrowed during prosecution simply because the applicants broadly disclose in this application but then might narrow their claims during prosecution. Finally, the entire disclosure of the patents and publications referred in this application are hereby incorporated herein by reference.

1-11. (canceled)

12. A method for treating a non-magnetic substrate of a magnetic recording medium, comprising providing the non-magnetic substrate to a holding fixture and treating a surface of the non-magnetic substrate in the presence of coolant, wherein the coolant comprises (i) a polyphosphoric acid, (ii) butoxyethanol or glycol ethers (iii) an additive to neutralize pH of the coolant, (iv) triethanolamine and (v) potassium hydroxide.

13. The method of claim 12, further comprising texturing the non-magnetic substrate and exposing the non-magnetic substrate to an acidic solution or acidic cleaner.

14. The method of claim 12, further comprising spaying de-ionized water on the non-magnetic substrate.

15. The method of claim 12, further comprising soaking the non-magnetic substrate in an alkaline soap solution.

16. The method of claim 12, further comprising soaking the non-magnetic substrate in an alkaline soap solution with ultrasonic agitation.

17. The method of claim 12, further comprising soaking the non-magnetic substrate in a de-ionized water bath with ultrasonic agitation.

18. The method of claim 12, further comprising scrubbing the non-magnetic substrate.

19. The method of claim 12, further comprising drying the non-magnetic substrate.

20. A method for treating a non-magnetic substrate of a magnetic recording medium, comprising providing the non-magnetic substrate to a holding fixture and treating a surface of the non-magnetic substrate in the presence of coolant, wherein the coolant comprises a polyphosphoric acid and butoxyethanol or glycol ether.

21. The method of claim 12, wherein 5 liters of the coolant contains about 50 g to about 1,000 g of the polyphosphoric acid, about 25 g to about 500 g of KOH, about 200 g to 2,000 g of 2-butoxy ethanol, about 100 g to about 1,200 g of triethanolamine and the balance of water.

22. The method of claim 12, wherein the non-magnetic substrate is aluminum or an aluminum-containing substrate.

23. The method of claim 22, wherein the coolant is an oxide scavenger.

24. The method of claim 12, wherein the polyphosphoric acid has a pH in the range of about 1.0 to 7.0.

25. The method of claim 12, wherein the coolant has a pH in the range of 2.0 to 7.0.

26. The method of claim 12, wherein the coolant is substantially non-foaming.

27. The method of claim 23, wherein the coolant produces a removal rate for the aluminum substrate of greater than 0.3 mil/min for at least 50 runs after dress of a grinding medium.

28. The method of claim 27, wherein the removal rate is greater than 0.8 mil/min.
